(19) United States
(12) Patent Application Publication
(10) Pub. No.: US 2010/0313134 A1
(43) Pub. Date: Dec. 9, 2010

(54) SYSTEM AND METHOD FOR PROVIDING SPATIAL AND TEMPORAL CONTENT IN AN ELECTRONIC DEVICE

(75) Inventors: Serge Rutman, Boulder Creek, CA (US); Mark Adkins, Sausalito, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: FIRSTPAPER LLC, New York, NY (US)

(21) Appl. No.: 12/481,336

(22) Filed: Jun. 9, 2009

(51) Int. Cl. G06F 3/01; G06F 15/16

(52) U.S. Cl. 715/730; 709/217

(57) ABSTRACT

A system for and method for displaying content with spatial and temporal components at an electronic reader device is presented. The system and method comprise an acquisition module for receiving a plurality of electronic content from one or more content sources via a network, a storage module for storing the plurality of electronic content, a selection module for selecting at least some of the plurality of electronic content for presentation, and a presentation module for presenting the selected electronic content at the electronic reader device, wherein the presented electronic content comprises a spatially and temporally persistent component and a spatially persistent and temporally transient component.

### BACKGROUND INFORMATION

A traditional newspaper is typically printed on large sheets of paper. Large sheets of paper allow multiple news items and other content (e.g., editorials, reviews, etc.) to be effectively shared with various advertising content. Because advertisements represent a large revenue stream, the amount of available space or “real estate” on each page of the newspaper is particularly valuable. However, as this traditional blend of newspaper content is shifted to newer electronic formats, a reduction in page real estate is unavoidable for electronic devices supporting these electronic formats that are no longer as large as traditional newspapers. The reason is because the costs of electronic paper/devices significantly increase with size, as well as various conflicting design factors affecting electronic devices, such as driving devices to modest “purse-sized” form factors needed for portability and mobility. Therefore, as page real estate begins to shrink to fit smaller electronic paper formats, optimizing an electronic page for presenting advertisement content becomes important. An original newspaper with advertisements to fit a smaller screen of an electronic reader device may not be a viable option simply because of scaling (e.g., scaling results in smaller font size and/or images which may be difficult to view on a small electronic device). As a result, conventional systems and methods do not provide a technique for optimizing page real estate for presenting content by providing spatial and/or temporal components in an electronic device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements.

FIG. 1 depicts a block diagram of a system for content distribution, according to an exemplary embodiment.

FIG. 2 depicts a module for presenting content at an electronic device using spatial and temporal components, according to an exemplary embodiment.

FIG. 3A-3B depict content presentment configurations using spatial and temporal components at an electronic device, according to exemplary embodiments.

FIG. 4 depicts an illustrative flowchart for presenting content at an electronic device using spatial and temporal components, according to an exemplary embodiment.

### DETAILED DESCRIPTION

Certain embodiments of the present invention provide electronic content access management on an electronic display device. More particularly, certain embodiments of the present invention provide a system for and method of managing electronic content access. Such electronic content may be accessed, by way of non-limiting example, via a device utilizing an electronic paper display (referred to herein as “EPD”), such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

As page real estate begins to shrink to fit smaller electronic paper formats, original content may not adequately scaled to fit within a given electronic page (e.g., image sizes, story sizes, etc.). For example, a full-sized advertisement typically presented in a traditional newspaper would not be able to fit, preserving its actual dimensions and size, within the confines of a much smaller portable handheld electronic device. Therefore, optimizing an electronic page for presenting advertisement content, without significant size alterations or dimension distortions, becomes important.

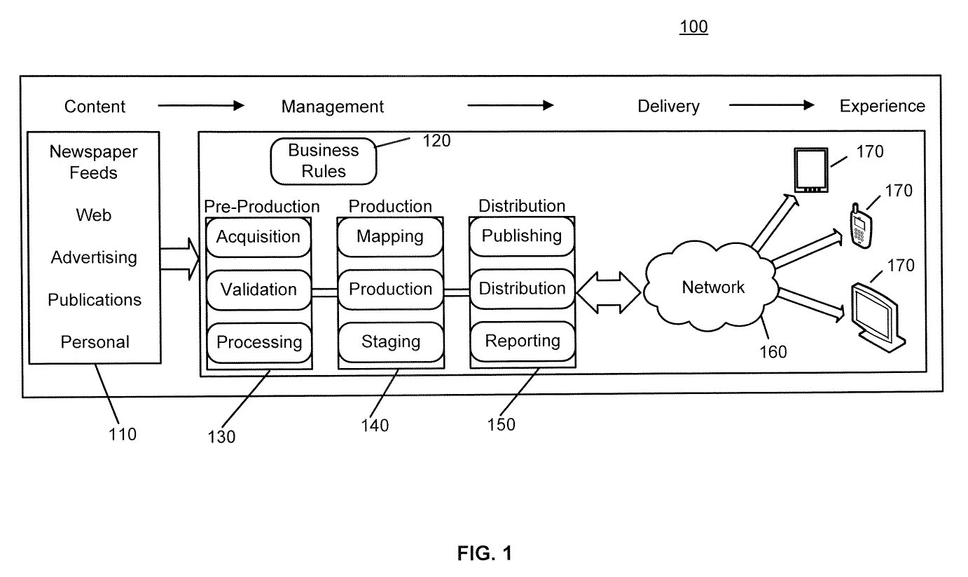

FIG. 1 depicts a block diagram of a system for content distribution, according to an exemplary embodiment. In some embodiments, the system 100 may by a content distribution system (CDN), which may include a content management system 110, a business rules system 120, a pre-production system 130, a production system 140, a distribution system 150 and one or more electronic devices 170. The distribution system 150 may distribute content to the one or more electronic devices 170 over a communications network 160. The communications network 160 may be any wired or wireless network. In one embodiment, the communication network may be an Internet Protocol (IP)-based network.

The content management system 110 may be communicatively coupled to the pre-production system 130, which in turn may be communicatively coupled to the production system 140. The production system 140 may be communicatively coupled to the distribution system 150. In some embodiments, content may be aggregated at the content management system 110 and outputted to the pre-production system 130 for validation and/or processing. The processed content may then be outputted from the pre-production system 130 and received at the production system 140 for mapping and/or staging. The mapped and staged content may then be outputted from the production system 140 and received at the distribution system 150 for publishing and/or distribution to the one or more electronic devices 170 over the communications network 160.

The pre-production system 130 may receive sourced content from the content management system 110 and output processed content to the production system 140. The production system 140 may received the processed content and output staged content to the distribution system 150. The distribution system 150 may receive the staged content and output approved content to one or more of the electronic devices 170.

The content management system 110 may include logic for gathering, aggregating, managing and/or storing content of various types. The types of content may include newspaper feeds, web content, advertising, publications, and/or personal information. In some embodiments, the content management system 110 may be configured to gather and/or aggregate content from one or more sources, categories, and/or content partners to the CDN 100 that provide content in association with the CDN 100. In some embodiments, the content may be gathered and/or aggregated automatically. In other embodiments, the content management system 110 may gather and/or aggregate the content based on one or more criteria. The criteria may include whether the content is perishable, curated, on-line, personal and/or other criteria.

The business rules system 120 may include a workflow engine configured to manage and/or execute modeled business processes. Each step in the operation of the workflow engine may be indicative of one or more business rules. The workflow engine may perform one or more actions based on the one or more business rules indicative of a specific template associated with a feed and/or publication in which content is received at the content management system 110. For example, in some embodiments, the one or more business rules may be completed for each article, publication, and/or advertisement processed through the workflow engine. In various embodiments, the business rules system 120 may include a workflow engine that operates according to one or more of the following rules: content enters the system through the feed; content is stored in a content repository, such as the content management system 110; various validation rules may be executed on the content; various pre-production rules are executed, the results of which may be stored back in the content management system 110; various production rules are executed, the results of which may be stored back in the content management system 110; the distribution system 150 may receive the results of the production system and distribute to electronic devices 170. In one embodiment, the CDN 100 may operate according to an amalgamation of the one or more business rules 120 as applied through the workflow engine.

Information relating to displayed content and/or related user actions may also be used by the business rules system 120 and/or other modules associated with electronic content distribution to enhance content delivery and presentment.

Exemplary content distribution networks are disclosed in U.S. application Ser. No. 12/248,482, titled “Systems, Methods and Apparatus for Content Distribution,” filed on Oct. 9, 2008 and U.S. provisional application No. 60/978,748, titled “Content Distribution and Preloading,” filed on Oct. 9, 2007, both of which are hereby incorporated by reference in their entireties.

It should be appreciated that the components/systems of the CDN 100 may be servers, network storage devices or other devices communicatively coupled to the communication network 160. In one or more embodiments, components/systems of the CDN 100 may perform any, or a combination, of storing, receiving, transmitting, producing, aggregating, and/or uploading electronic content. The components/systems of the CDN 100 may also perform other electronic content management functionality including, but not limited to, any, or a combination, of account management, electronic payment processing and verification, target marketing of electronic content to electronic display device users, user electronic content tracking, and content distribution.

In some embodiments, the components/systems of the CDN 100 may contain or be communicatively coupled to storage, such as a redundant array of inexpensive disks (RAID), a storage area network (SAN), an internet small computer systems interface (iSCSI) SAN, a Fibre Channel SAN, a common Internet File System (CIFS), network attached storage (NAS), a network file system (NFS), tape drive based storage, or other computer accessible storage.

Additionally, components/systems of the CDN 100 may communicate with any, or a combination, of other systems, applications, and storage locations directly via one or more of an Application Programming Interface (API), a Remote Procedure Call (RPC), an interface table, a web service, an Extensible Markup Language (XML) based interface, a Simple Object Access Protocol (SOAP) based interface, a common request broker architecture (CORBA) based interface, and other interfaces for sending or receiving information. For example, components/systems of the CDN 100 may communicate with accounting systems, marketing systems, interactive voice response (IVR) systems, systems of content providers, or other systems, servers, or components to facilitate electronic content caching and transactions.

Components/systems of the CDN 100 may each be responsible for different functionality in an electronic content distribution network. By way of non-limiting example, the components/systems of the CDN 100 may produce, receive, organize and aggregate electronic content, such as periodicals, books, newsletters, or other electronic content. Such electronic content may be aggregated from one or more feeds, such as publishers, resellers, newspapers, journalists, news services, broadcasts, or other sources. Processing of electronic content may include any, or a combination, of indexing, categorizing, storing, formatting, translating, filtering, spell checking, compressing, encrypting, securing, replicating, and further processing. Electronic content may be produced by user or third-party input (e.g., blogs, newsletters, etc.). Such content may be input via, by way of non-limiting example, typed input or dictations processed by speech to text input (e.g., text of speeches, conferences, proceedings, hearings, etc.). Electronic content may be produced by scanning existing text, such as by way of non-limiting example, by Optical Character Recognition (OCR) processes. Other scanning processes may produce electronic content without performing OCR processes. The components/systems of the CDN 100 may translate content from one format to another. For example, The components/systems of the CDN 100 may receive content from a subscriber and may translate the content into one or more electronic formats including, but not limited to, proprietary formats utilized by one or more e-book readers. The components/systems of the CDN 100 may receive subscriber or user content via emails, FTP (File Transfer Protocol), HTTP (Hyper Text Transfer Protocol), text message (e.g., via Short Message Service (SMS)), Multi-Media Messaging Service (MMS), Wireless Access Protocol (WAP), or via other electronic communication protocols. Categorization of content by the components/systems of the CDN 100 may include any, or a combination, of organizing content, storing content, and indexing content by one or more of a subject, subscription, and access. By way of non-limiting example, content may be grouped or stored in databases or other storage which may be separated according to subscription.

The network 160 may be any network, such as a local area network (LAN), a wide area network (WAN), a service provider network, the Internet, or other similar network. In some embodiments, the network 160 may be a service provider network. It should be appreciated that the network may use electric, electromagnetic, and/or optical signals that carry digital data streams.

The one or more electronic devices 170 may be electronic book (e-book) readers and/or E-Ink® devices. In other embodiments, the one or more electronic devices 170 may be desktop computers, laptops/notebooks, servers or server-like systems, modules, Personal Digital Assistants (PDAs), smart phones, cellular phones, mobile phones, satellite phones, MP3 players, video players, personal media players, personal video recorders (PVR), watches, gaming consoles/devices, navigation devices, televisions, printers, and/or other devices capable of receiving and/or transmitting signals and/or displaying electronic content. It should be appreciated that the network element 102 may be mobile, handheld, or stationary. It should also be appreciated that the one or more electronic devices 170 may be used independently or may be used as an integrated component in another device and/or system.

In some embodiments, electronic display devices 170 may access electronic content locally via one or more device interfaces. For example, the one or more electronic devices 170 may transmit and receive data to and from network 160 utilizing a standard telecommunications protocol or a standard networking protocol. By way of non-limiting example, one embodiment may utilize FTP (File Transfer Protocol), HTTP (Hyper Text Transfer Protocol), Wireless Application Protocol (WAP), Multimedia Messaging Service (MMS), Enhanced Messaging Service (EMS), Short Message Service (SMS), Global System for Mobile Communications (GSM) based systems, Transmission Control Protocol/Internet (TCP/IP) Protocols, or other protocols or systems suitable for transmitting and receiving electronic content data. Electronic content may be transmitted and received wirelessly or may utilize cabled network or telecom connections such as an Ethernet RJ45/Category 5 connection, a fiber connection, a traditional phone wireline connection, a cable connection or other wired network connection. The one or more electronic devices 170 may use standard wireless protocols including IEEE 802.11 and 802.16. The one or more electronic devices 170 may also be connected to network 102 via protocols for a wired connection, such as an IEEE Ethernet 802.3.

By way of non-limiting example, the one or more electronic devices 170 may also contain one or more interfaces including a USB (Universal Serial Bus) connection, an RS-232 or serial connection, a Bluetooth connection, an RFID (Radio Frequency IDentification) reader or interrogator, an RFID tag (active or passive), a firewire connection, or interfaces supporting storage media (e.g., flash memory cards, CDs, DVDs). Electronic content may be received by an end user on electronic storage media and may be loaded onto or accessed by an electronic display device via one or more interfaces.

It should also be appreciated that while the components/systems of the CDN 100 are shown as separate components, these may be combined into greater or lesser components to optimize flexibility. For example, while the content management system 110, pre-production system 130, production system 140, and distribution system 150 are depicted as separate components/systems, it should be appreciated that these components/systems may be integrated into a single component. Other various embodiments may also be realized.

It should be appreciated that each of the components/systems of the CDN 100 may be physical and/or virtual servers, modules, storage, devices, systems, etc. Each of the components/systems of the CDN 100 may also communicate with each other via one or more network communications. Other various embodiments may also be provided.

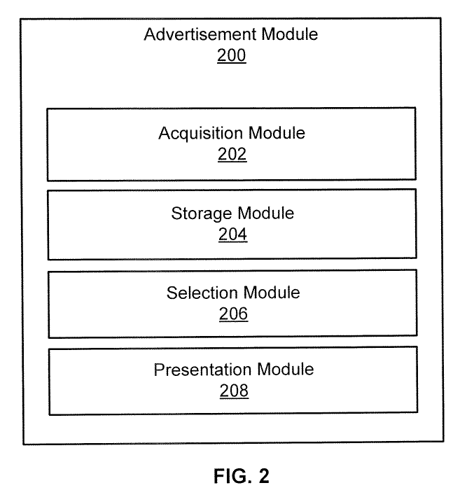

FIG. 2 depicts a module for presenting content at an electronic device using spatial and temporal components, according to an exemplary embodiment. The module may be an advertisement module 200. The advertisement module 200 may be a part of the content management system 110, the pre-production system 130, the production system 140, the distribution system 150, and/or the one or more electronic devices of the CDN 100. The advertisement module 200 may implemented in hardware, software, or a combination thereof.

The advertisement module 200 may include a variety of other components/modules, such as an acquisition module 202, a storage module 204, a selection module 206, a presentation module 208, and/or other modules. The acquisition module 202 may receive a plurality of electronic content (e.g., electronic advertisement content) from one or more content sources. The storage module 204 may store the received electronic content. The selection module 206 may select at least some of the plurality of electronic content for presentation. The presentation module 208 may present the selected electronic content at an electronic device, wherein the presented electronic content comprises a spatially and temporally persistent component and a spatially persistent and temporally transient component.

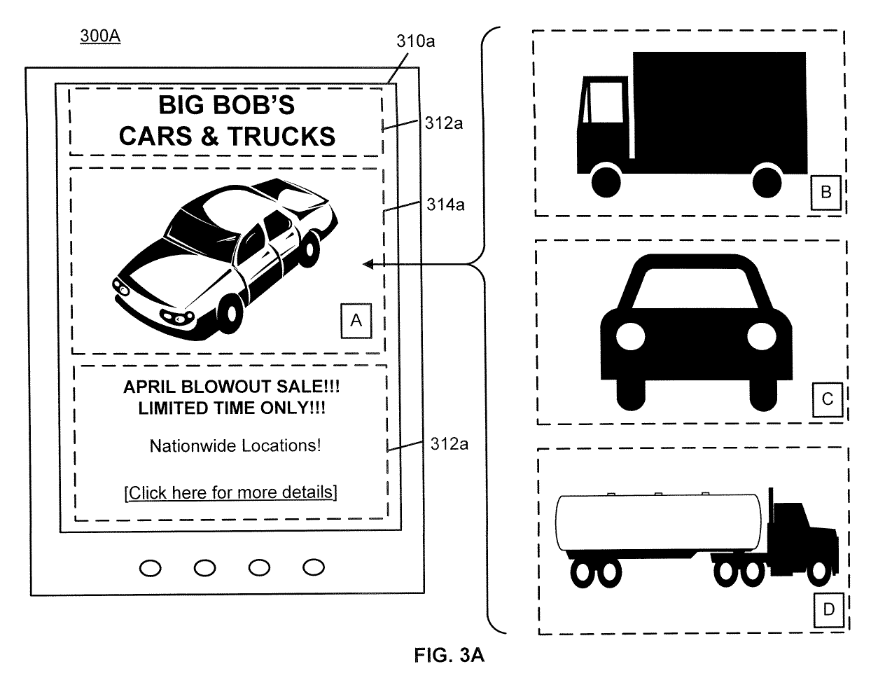

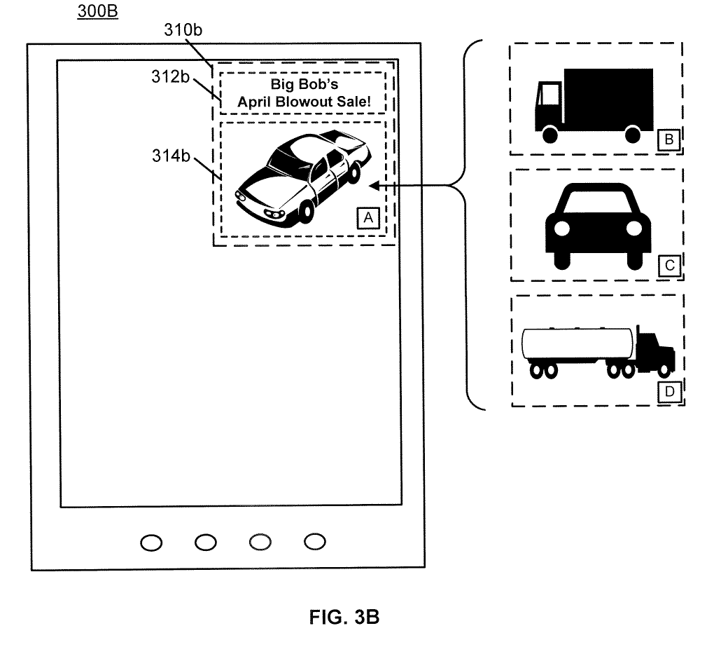

FIG. 3A-3B depict content presentment configurations using spatial and temporal components at an electronic device, according to exemplary embodiments. For example, FIG. 3A depicts a full display configuration 300A of an electronic device 170 (e.g., an electronic reader device) with an advertisement 310a for “Big Bob's Cars & Trucks” on its display. In this embodiment, the electronic advertisement content 310a may be presented within an entire display 310a of the electronic device 170.

The advertisement 310a may have several components, such as at least one spatially and temporally persistent component 312a and/or at least one spatially and temporally transient component 314a. The spatially and temporally persistent component 312a of the advertisement 310a may include text, graphics, and/or other content that occupies a predetermined amount of space on the display. The spatially and temporally persistent component 312a may remain persistent (unchanging) for a duration of the displayed advertisement 310a. Referring to FIG. 3, the spatially and temporally persistent component 312a may display “Big Bob's Cars & Trucks” text in a persistent manner.

The spatially and temporally transient component 314a may also include text, graphics, and/or other content. However, the spatially and temporally transient component 314a of the advertisement 310a may dynamically change over a predetermined amount of time. For example, in FIG. 3A, the spatially and temporally transient component 314a of the advertisement 310a may pictorially display the various cars and trucks that “Big Bob” wants to show in the advertisement. Here, in this example, there are four (4) pictorial images of cars and trucks (e.g., A, B, C, and D). These pictorial images may be displayed within the spatially and temporally transient component 314a of the advertisement 310a in a sequential order. For example, each of A, B, C, and D may each be displayed for ten seconds sequentially. After D is displayed, the pictorial image may loop back to A. In other embodiments, these pictorial images may be displayed within the spatially and temporally transient component 314a of the advertisement 310a in a random order. It should also be appreciated that while only four (4) items are being displayed in the spatially and temporally transient component 314a of the advertisement 310a, a greater or lesser number of items may be presented. Other various embodiments may also be realized.

The advantage of providing a spatially and temporally transient component 314a of within the advertisement 310a may be to substantially preserve the size and/or dimensions of a traditional advertisement. For example, in a traditional newspaper format, each of the cars and trucks A-D may all be presented entirely single page of a news paper advertisement. Big Bob may be willing to pay for the large “real estate.” However, in an electronic paper format, Big Bob's traditional advertisement would not fit within the confines of an electronic reader device. But because the four pictorial images A-D may be displayed separately, and in substantially the same size and/or dimension as that of the traditional advertisement, Big Bob's advertisement may still be “fitted” and optimized in an electronic paper format. Therefore, for all intended purposes, the advertisement 310a in electronic format may have the same effect on a consumer viewing the advertisement in a traditional format.

It should be appreciated that the electronic advertisement content 310a may also include hyperlinks and/or other interactivity option for a user to interact. For example, a user may click/touch a hyperlink to retrieve more information about the advertisement. Another example, a user interact with the electronic advertisement content 310a by physically printing out a coupon from a printer communicatively coupled to the electronic device. Other various embodiments to preserve or replicate traditionally presented advertisement content may also be provided.

FIG. 3B depicts a partial display configuration 300B of an electronic device 170 (e.g., an electronic content reader) with an advertisement for “Big Bob's” on a portion of its display screen 310b. In this embodiment, it should be appreciated that the advertisement may be displayed using a portion of the display. Similar to FIG. 3A above, the advertisement 310b may also include at least one spatially and temporally persistent component 312b and/or at least one spatially and temporally transient component 314b.

While only one advertisement 310b is depicted in the partial display configuration 300B, it should be appreciated that one or more additional electronic advertisement content may also be displayed with the advertisement 310b on the same page. Moreover, the advertisement may be viewed concurrently with other non-advertisement content.

Although presentment of these electronic advertisements, as described above, do not depend on general topic/subject a particular user chooses to read/consume, acquiring information relating to displayed electronic content may be used to enhance size, placement, and/or associated costs of advertisements. For example, when electronic content (e.g., an advertisement) is displayed at an electronic device, information relating to the displayed content may be acquired. The information may include time of day/week/year of display, duration of display, geographical location(s) of electronic device during display, location of displayed electronic content on a screen, number of times displayed, and/or any related user actions to the displayed content. It should be appreciated that the related user actions may include clicking a hyperlink, calling the advertiser if device is suitably equipped for making calls, bookmarking the advertisement, forwarding the advertisement to one or more friends, printing the advertisement, etc. This information may be used to determine habits/trends of a user, for example, which may be used to further determine its effectiveness and/or associated price/cost. In some embodiments, this information may be stored and processed by the advertisement module 200 to determine what advertisements to display and how/where to present them.

By presenting advertisements with spatial and temporal components and/or acquiring information associated to the displayed content, preservation and effect of traditional advertisements may be provided. In addition to the benefits described above, embodiments of the system and method for presenting electronic advertisement content using spatial and temporal components not only provide an effective and improved technique for offering and selling products, but also may allow advertisers to more effectively service the consumer pool without any additional work. Moreover, advantages in business and marketing strategies may also become increasingly apparent. These benefits and opportunities may not otherwise be provided by conventional advertising techniques in electronic devices, which may typically reduce a full-page traditional advertisement and ultimately decrease its original effect on consumers.

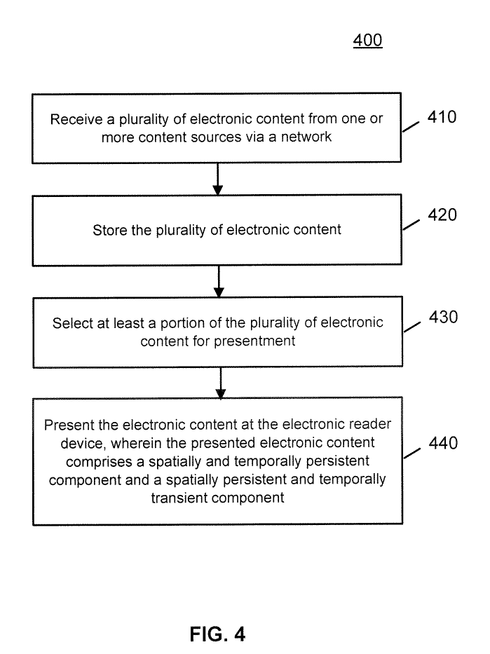

FIG. 4 depicts an illustrative flowchart for presenting content at an electronic device using spatial and temporal components, according to an exemplary embodiment. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least system 100 in FIG. 1, by way of example, and various elements of system 100 are referenced in explaining the example method of FIG. 4. Each block shown in FIG. 4 represents one or more processes, methods, or subroutines carried in the exemplary method 400. A computer readable media comprising code to perform the acts of the method 300 may also be provided. Referring to FIG. 4, the exemplary method 400 may begin at block 410.

At block 410, the acquisition module 202 may receive a plurality of electronic content from one or more content sources via a network. In some embodiments, the electronic content may comprise advertisement content.

At block 430, the storage module 204 may store the plurality of electronic content. The electronic content may be stored for short term or long term.

At block 430, the selection module 206 may select at least some of the plurality of electronic content for presentation. In some embodiments, the selection module 206 may select electronic content based on one or more selection rules. In other embodiments, the selection module 206 may select electronic content based on one or more rules pertaining to presentment (e.g., in a spatially and temporally transient frame).

At block 440, the presentation module 208 may present the electronic content at a display device. In some embodiments, the presentation module 208 may present electronic content based on one or more presentment rules. In other embodiments, the presented electronic content may include at least one spatially and temporally persistent component and at least one spatially persistent and temporally transient component.

The presentation module 208 may fit the electronic content in an entire display portion of the electronic reader device. In other embodiments, the presentation module 208 may fit the electronic content in at least a display portion of the electronic reader device.

When the present module 208 presents the electronic content, the spatially and temporally persistent component may be related in content to the spatially persistent and temporally transient component. In some embodiments, the spatially and temporally persistent component presents electronic content in a persistent frame. In other embodiments, the spatially persistent and temporally transient component may optimize presentment of the selection electronic content. For example, the spatially persistent and temporally transient component may dynamically present the electronic content. As described above, the selected electronic content may be presented in sequential or random order.

It should be appreciated that while embodiments are directed to at least one spatially and temporally persistent component and at least one spatially and temporally transient component, other various embodiments may also be provided. For example, the advertisement may include a spatially transient and temporally persistent and/or a spatially persistent and temporally transient component. Other various embodiments may also be provided.

While the features and functionalities of the systems and methods are primarily directed to electronic advertisements, it should be appreciated that the features and functionalities of may be applied to other content as well. Furthermore, while the advertisement content is described primarily in a visual display, it should be appreciated that the content may include multimedia, audio, and/or other presentments.

In the preceding specification, various preferred embodiments have been described with references to the accompanying drawings. It will, however, be evident that various modifications and changes may be made thereto, and additional embodiments may be implemented, without departing from the broader scope of invention as set forth in the claims that follow. The specification and drawings are accordingly to be regarded in an illustrative rather than restrictive sense.

We claim:

1. A system for displaying content with spatial and temporal components at an electronic reader device, comprising:
an acquisition module for receiving a plurality of electronic content from one or more content sources via a network;
a storage module for storing the plurality of electronic content;
a selection module for selecting at least some of the plurality of electronic content for presentation; and
a presentation module for presenting the selected electronic content at the electronic reader device, wherein the presented electronic content comprises a spatially and temporally persistent component and a spatially persistent and temporally transient component.

2. The system of claim 1, wherein the electronic content comprises advertisement content.

3. The system of claim 1, wherein the presentation module fits the electronic content in an entire display portion of the electronic reader device.

4. The system of claim 1, wherein the presentation module fits the electronic content in at least a display portion of the electronic reader device.

5. The system of claim 1, wherein the spatially and temporally persistent component is related in content to the spatially persistent and temporally transient component.

6. The system of claim 1, wherein the spatially and temporally persistent component presents electronic content in a persistent frame.

7. The system of claim 1, wherein the spatially persistent and temporally transient component optimizes presentation of the selection electronic content.

8. The system of claim 7, wherein the spatially persistent and temporally transient component dynamically presents the electronic content.

9. The system of claim 8, wherein the selected electronic content is presented in a sequential order.

10. The system of claim 8, wherein the selected electronic content is presented in a random order.

11. A method for displaying content with spatial and temporal components at an electronic reader device, comprising:
receiving, at an acquisition module using at least one computer processor, a plurality of electronic content from one or more content sources via a network;
storing, at a storage module using the at least one computer processor, the plurality of electronic content;
selecting, at a selection module using at least one computer processor, at least some of the plurality of electronic content for presentation; and
transmitting, by a presentation module using the at least one computer processor, the selected electronic content at the electronic reader device, wherein the presented electronic content comprises a spatially and temporally persistent component and a spatially persistent and temporally transient component.

12. The method of claim 11, wherein the electronic content comprises advertisement content.

13. The method of claim 11, wherein the presentation module fits the electronic content in an entire display portion of the electronic reader device.

14. The method of claim 11, wherein the presentation module fits the electronic content in at least a display portion of the electronic reader device.

15. The method of claim 11, wherein the spatially and temporally persistent component is related in content to the spatially persistent and temporally transient component.

16. The method of claim 11, wherein the spatially and temporally persistent component presents electronic content in a persistent frame.

17. The method of claim 11, wherein the spatially persistent and temporally transient component optimizes presentation of the selection electronic content.

18. The method of claim 17, wherein the spatially persistent and temporally transient component dynamically presents the electronic content.

19. The method of claim 18, wherein the selected electronic content is presented in a sequential order.

20. The method of claim 18, wherein the selected electronic content is presented in a random order.

21. A computer readable medium comprising code to perform the acts of the method of claim 12.
